(19) United States
(12) Patent Application Publication
(10) Pub. No.: US 2026/0109238 A1
(43) Pub. Date: Apr. 23, 2026

(54) RANGE EXTENDED BATTERY ELECTRIC VEHICLE CONFIGURED TO PROVIDE ONBOARD DIAGNOSTIC SIGNALS

(71) Applicant: SCOUT MOTORS INC., Tysons, VA (US)

(72) Inventors: Markus ULRICH, West Bloomfield Township, MI (US); Steffen DOHSE, Ann Arbor, MI (US); Michael ADE, Grass Lake, MI (US)

(21) Appl. No.: 18/923,848

(22) Filed: Oct. 23, 2024

(51) Int. Cl. B60L 50/61; B60K 6/42; B60L 50/15

(52) U.S. Cl. CPC B60L 50/61; B60K 6/42; B60L 50/15; B60L 2240/44

(57) ABSTRACT

A battery electric vehicle (BEV) is provided that includes a vehicle frame and a power train carried by the vehicle frame and configured to provide motive force to the BEV in response to electrical power provided thereto. The BEV also includes a battery system that includes a battery controller and one or more batteries responsive to battery control signals provided by the battery controller in order to provide the electrical power to the power train. The BEV further includes an internal combustion engine (ICE) system to extend a range of the BEV. The ICE system includes a plurality of ICE components including an ICE and a generator driven by the ICE. The BEV additionally includes an electronic control unit (ECU) configured to receive on board diagnostic (OBD) signals from the ICE system and signals from the battery system for meeting OBD requirements.

### BACKGROUND

Battery electric vehicles, more generally referred to as electric vehicles (EVs), have experienced widespread adoption in recent years and are predicted to continue to grow in popularity. EVs are generally efficient and produce few, if any, emissions while driving. As a result, EVs have been exempted from the regulations that mandate the provision of onboard diagnostic (OBD) signals for vehicles having internal combustion engines.

The capacity of EV batteries and lack of sufficient EV charging infrastructure may lead to range anxiety in drivers, where an EV driver becomes anxious with respect to the remaining vehicle range based on battery charge level. To address range anxiety concerns, EV manufacturers may consider adding a traditional internal combustion engine (ICE) to supplement the batteries in the EV. Once an ICE is added to an EV, however, the entire vehicle must comply with OBD requirements. Integrating the electrical architecture of the ICE engine into the electrical architecture of the EV in a way that meets OBD requirements for not only the ICE but also the existing EV components may be costly and challenging.

### SUMMARY

A battery electric vehicle (BEV) and an associated power system and method are provided in accordance with an example embodiment with the BEV including an internal combustion engine (ICE) system in order to extend the range of the BEV. With the addition of the ICE system, OBD signals must be provided for diagnostic purposes even though the battery system of the BEV was not mandated to and did not provide OBD signals, such as for diagnostic purposes, prior to the addition of the ICE system in order to extend the range of the BEV. As such, the range extended BEV is configured to provide OBD signals from both the ICE system and the battery system in a manner that limits or avoid modifications to the battery system, thereby permitting the BEV to be range extended by the addition of an ICE system in an efficient manner with reduced complexity and cost.

In one aspect, a battery electric vehicle is provided that includes a vehicle frame and a power train carried by the vehicle frame and configured to provide motive force to the battery electric vehicle in response to electrical power provided thereto. The battery electric vehicle also includes a battery system that includes a battery controller and one or more batteries responsive to battery control signals provided by the battery controller in order to provide the electrical power to the power train. The battery electric vehicle further includes an internal combustion engine (ICE) system to extend a range of the battery electric vehicle. The ICE system includes a plurality of ICE components including an ICE and a generator driven by the ICE. The battery electric vehicle additionally includes an on board diagnostic (OBD) electronic control unit (ECU), separate from the battery system, that is configured to receive OBD signals from the ICE system and signals from the battery system for meeting OBD requirements.

In an example embodiment, the OBD ECU is configured to generate OBD signals for the battery system based at least in part on the signals received from the battery system. The battery electric vehicle of this embodiment may also include an OBD port configured to receive the OBD signals from the OBD ECU and to output the OBD signals to an external device. In this embodiment, the battery system may be dependent upon the OBD ECU to output the OBD signals toward the OBD port as the battery system is not configured to provide OBD signals directly to the OBD port. The OBD ECU of this embodiment may also be configured to analyze at least some of the OBD signals from the ICE system or some of the signals from the battery system in accordance with a predefined algorithm to detect existence of a fault, and to output an indication of the fault as an OBD signal toward the OBD port.

The battery system of an example embodiment includes a plurality of battery components including the battery controller, the one or more batteries, an e-machine, an inverter, and a battery thermal system. The OBD ECU of this embodiment is configured to receive the signals from one or more of the plurality of battery components. In this embodiment, the ICE system may also include an ICE electrical control unit that is configured to receive OBD signals from one or more of the ICE or the generator, and the ICE electrical control unit may also be configured to receive signals from one or more of the plurality of battery components, such that the ICE electrical control unit functions as the OBD ECU.

The OBD ECU of an example embodiment is also configured to receive predefined types of signals from the battery controller. In one embodiment, the OBD ECU is configured to receive the signals from the battery system without the signals having been processed by the battery system. The battery system of an example embodiment also includes a battery system ECU configured to receive the signals from other battery components including the one or more batteries. In this embodiment, the OBD ECU is configured to receive the signals from the battery system by receiving the signals from the battery system ECU. The OBD ECU of an example embodiment is configured to receive signals from at least one of the ICE system or the battery system that include the OBD signals and other types of signals. In this embodiment, the OBD ECU is configured to filter the signals that are received to separate the OBD signals from the other types of signals.

In another aspect, a power system of a battery electric vehicle is provided. The power system includes a battery system and an internal combustion engine (ICE) system. The battery system includes a battery controller and one or more batteries responsive to battery control signals provided by the battery controller in order to provide the electrical power to a power train of the battery electric vehicle. The ICE system is configured to extend a range of the battery electric vehicle. The ICE system includes a plurality of ICE components including an ICE and a generator driven by the ICE. The power system further includes an on board diagnostic (OBD) electronic control unit (ECU), separate from the battery system, that is configured to receive OBD signals from the ICE system and signals from the battery system for meeting OBD requirements.

The OBD ECU of an example embodiment is configured to generate OBD signals for the battery system based at least in part on the signals received from the battery system. In this embodiment, the power system may also include an OBD port configured to receive the OBD signals from the OBD ECU and to output the OBD signals to an external device. The battery system of this embodiment may be dependent upon the OBD ECU to output the OBD signals toward the OBD port as the battery system is not configured to provide OBD signals directly to the OBD port. In this embodiment, the OBD ECU may be configured to analyze at least some of the OBD signals from the ICE system or some of the signals from the battery system in accordance with a predefined algorithm to detect existence of a fault, and to output an indication of the fault as an OBD signal toward the OBD port. The OBD ECU of an example embodiment is configured to receive the signals from the battery system without the signals having been processed by the battery system.

In a further aspect, a method for integrating an internal combustion engine (ICE) system with a battery system of a battery electric vehicle is provided. The method includes providing electrical power from one or more batteries of the battery system to a power train of the battery electric vehicle in response to battery control signals from a battery controller of the battery system. The method also includes providing auxiliary power with the ICE system. The ICE system includes a plurality of ICE components including an ICE and a generator driven by the ICE and configured to provide the auxiliary power in order to extend a range of the battery electric vehicle. The method additionally includes receiving, with an on board diagnostic (OBD) electronic control unit (ECU) that is separate from the battery system, OBD signals from the ICE system and signals from the battery system for meeting OBD requirements.

The method of an example embodiment also includes generating, with the OBD ECU, OBD signals for the battery system based at least in part on the signals received from the battery system. The method of this embodiment also includes outputting the OBD signals received from the OBD ECU via an OBD port of the batter electric vehicle. In this embodiment, the method may also include analyzing, with the OBD ECU, at least some of the OBD signals from the ICE system or some of the signals from the battery system in accordance with a predefined algorithm to detect existence of a fault and outputting an indication of the fault as an OBD signal from the OBD ECU toward the OBD port.

### DESCRIPTION OF THE DRAWINGS

Having thus described certain example embodiments of the present disclosure in general terms, reference will hereinafter be made to the accompanying drawings which are not necessarily drawn to scale, and wherein:

FIG. 1 is a sideview of a battery electric vehicle (BEV) that includes a battery system and an internal combustion engine (ICE) system in accordance with an example embodiment of the present disclosure;

FIG. 2 is a top view of the vehicle frame of the BEV of FIG. 1 that depicts the relative locations of the battery system and the ICE system in accordance with an example embodiment of the present disclosure;

FIG. 3 is a block diagram of a BEV including a battery-driven power train in accordance with an example embodiment of the present disclosure;

FIG. 4 is a block diagram of a battery system and an ICE system of a BEV in accordance with an example embodiment of the present disclosure; and

FIG. 5 is a flow chart illustrating the operations performed in order to provide OBD signals for both the battery system and the ICE system of a BEV in accordance with an example embodiment of the present disclosure.

### DETAILED DESCRIPTION

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

Several vehicle types employ electric propulsion using batteries and electric motors. Hybrid electric vehicles (HEVs) are vehicles that generally employ small, high voltage batteries, e.g., batteries supplying more than 100 volts, supplying energy to the one or more electric machines or e-machines, e.g., electric motors, to drive the wheels. HEVs also include an auxiliary power unit (APU) that generally includes an internal combustion engine to recharge or maintain the charge of the battery. HEVs require the APU as their batteries generally do not support a range of more than 50 miles, and often less than 25 miles. Plug-in hybrid electric vehicles (PHEVs) are similar to HEVs, but offer the option to a user to plug in the vehicle, such as at a recharging station, in order to charge the modest battery. In contrast, battery electric vehicles (BEVs) are purely electrically propelled vehicles that do not rely on an APU and generally have a considerably larger battery than HEVs and PHEVs. As such, the range of a BEV generally rivals that of their gasoline or diesel contemporaries.

Vehicle range is a critical limitation of BEVs, both operationally and for purposes of furthering the adoption of EVs. A number of limitations on the range of BEVs exist. For example, there remain regions that lack sufficient BEV charging infrastructure. Moreover, even in the regions that have electric charging stations, the demand for electric charging stations sometimes exceeds the availability of electric charging stations in some regions. Further, the reliability of the charging infrastructure including charging stations that are not fully functioning may be an issue, particularly as the charging stations continue to age.

As such, it is desirable to increase the range of BEVs to enable BEVs to be more freely driven, while reducing user concerns regarding the vehicle range. One mechanism to increase range is to increase the size and capacity of the battery of a BEV. However, batteries are relatively heavy and expensive such that an increase in battery capacity often comes with a cost increase for a vehicle and a weight penalty which cuts against the range increase.

A battery electric vehicle is therefore provided in accordance with an example embodiment wherein an internal combustion engine (ICE) system has been added to extend the range of the battery electric vehicle, resulting in a range extended battery electric vehicle. The ICE system may provide auxiliary power for various purposes, such as to recharge the battery and/or to directly provide power to one or more other components of the battery electric vehicle including, for example, the power train of the battery electric vehicle. Conventional electric vehicles may not include an ICE system. Therefore, the inclusion of the ICE system in the BEV may offer performance improvements compared with conventional electric vehicles because the BEV with the ICE system may power the electric machines via the battery system and/or the ICE system.

The ICE system of an example embodiment may be configured to be permanently or removably attached to a vehicle frame, such as during production of the vehicle on an assembly line or following manufacture, such as at a dealer as an accessory or as a retrofit to a used vehicle. As described below, the ICE system not only supplements the battery system in order to extend the range of the battery electric vehicle, but the ICE system is added to the battery system of a battery electric vehicle in such a manner as to facilitate the battery electric vehicle's compliance with the on board diagnostic (OBD) requirements with little, if any, modification of the existing battery electric vehicle electrical architecture and system. Once an ICE is added to the battery electric vehicle, the existing battery electric vehicle components must also begin to satisfy the OBD requirements. In that regard, any input sensor of the vehicle that can cause an increase in emissions or impact on vehicle range, whether related to the ICE or battery system, is required to be monitored, such as for failure or other errors, and corresponding OBD signals are to be provided. In this regard, the ICE system that is added to the battery electric vehicle in order to supplement the battery system of the battery electric vehicle is added in such a manner as to provide for OBD compliance, both for the ICE system as well as for the battery system that did not have to comply with the OBD requirements prior to the addition of the ICE system. In contrast, an ICE vehicle adding a battery must only ensure that the added battery components comply with OBD requirements as the existing ICE vehicle already does. As such, the addition of an ICE system to provide a range extended battery electric vehicle may be performed more efficiently and with less complexity while still satisfying the OBD requirements that are imposed upon both the ICE system and the battery system once the ICE system is added to the battery electric vehicle.

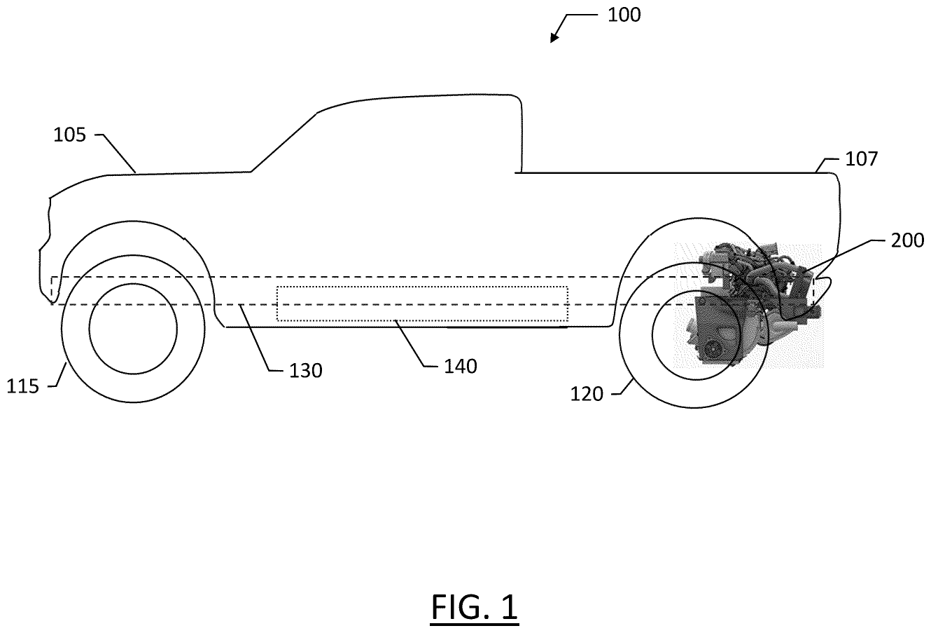

An example embodiment of a range extended BEV 100 is depicted in FIG. 1. The illustrated embodiment includes a truck or pickup truck having a bed, however, the range extended BEV may include any of a wide variety of other types of vehicles including a car, sport utility vehicle, rugged sport utility vehicle, crossover vehicle, commercial vehicle, etc. Thusly, the embodiments described herein are not intended to limit the type of vehicle that can benefit from the addition of an ICE system that satisfies the OBD requirements in an efficient manner as described herein.

The BEV 100 of FIG. 1 is illustrated to include front wheels 115 and rear wheels 120, and depicted in dashed lines is the general position and shape of a vehicle frame 130. Vehicle frames can be complex in shape, although the illustrated vehicle frame 130 is a simplified example of a vehicle frame that extends longitudinally along a length of the BEV 100 in a body-on-frame arrangement in which the body 105 of the vehicle and the bed 107 are mounted atop the vehicle frame 130. In other embodiments, the BEV 100 may utilize a unibody structure or hybrid structure having a unibody structure for the passenger compartment and/or the middle of the vehicle with frame rails extending fore and aft in a unitized platform-type frame. As such, the illustration and description of a body-on-frame arrangement is not intended to limit the type of frames that may be utilized by a range extended battery electric vehicle of the present disclosure.

FIG. 1 also depicts one example of a position of a battery system 140 relative to the frame 130 of a BEV 100. The battery system 140 may include one or more batteries, also sometimes referred to as a battery pack, high-voltage battery assembly or traction battery, that are generally relatively heavy such that positioning the battery system 140 in a centrally located and a relatively low position provides improved handling and stability characteristics of the vehicle. However, the battery system 140 may be positioned in other locations relative to the frame 130 of a BEV 100 in other embodiments if so desired.

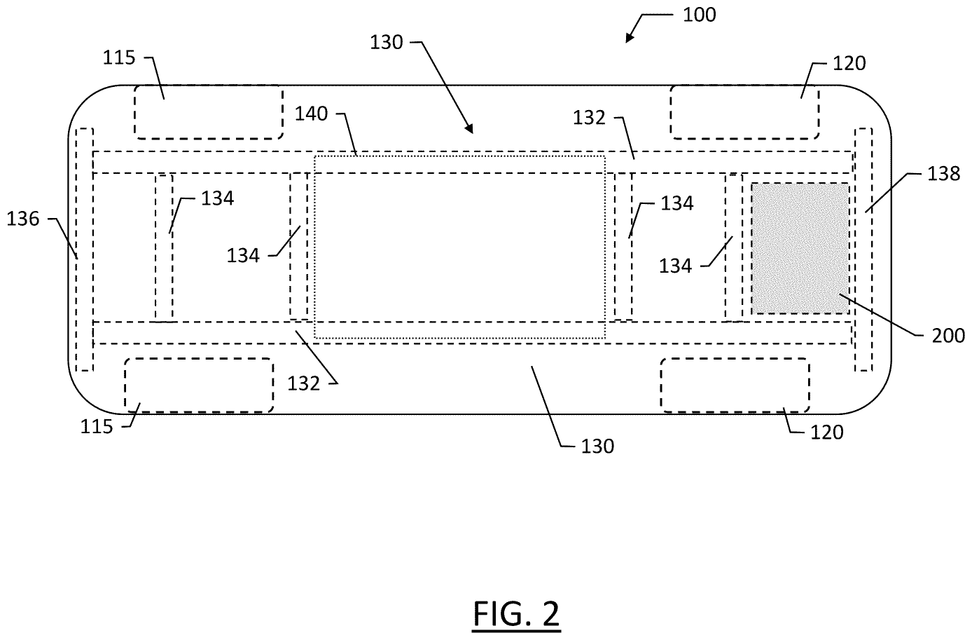

As shown in FIG. 2, a top view of a range extended BEV 100 is depicted with the vehicle frame 130 shown in dashed lines. The vehicle frame 130 of this example embodiment is positioned between the two front wheels 110 and between the two rear wheels 120. In this example embodiment, the vehicle frame 130 also includes one or more side rails 132 that extend longitudinally along the length of the BEV 100 and cross members 134 that extend between the two frame rails 132. Also shown is a front bumper bar 136 and a rear bumper bar 138, attached to the frame rails 132. The battery system 140 is shown generally by a dotted line and is carried by a central portion of the vehicle frame 130. As shown in both FIGS. 1 and 2, an ICE system 200 of an example embodiment is positioned proximate the rear end of the BEV 100 in between the frame rails 132 to which the ICE system 200 is securely mounted. In an example embodiment, the ICE system 200 can be easily installed and removed to facilitate the range extension of a BEV 100 by providing auxiliary power for a variety of purposes including, for example, for charging the one or more batteries of the battery system 140 of the BEV 100. However, the battery system 140 and the ICE system 200 can be differently positioned relative to the vehicle frame 130 and/or relative to the BEV 100 in other embodiments.

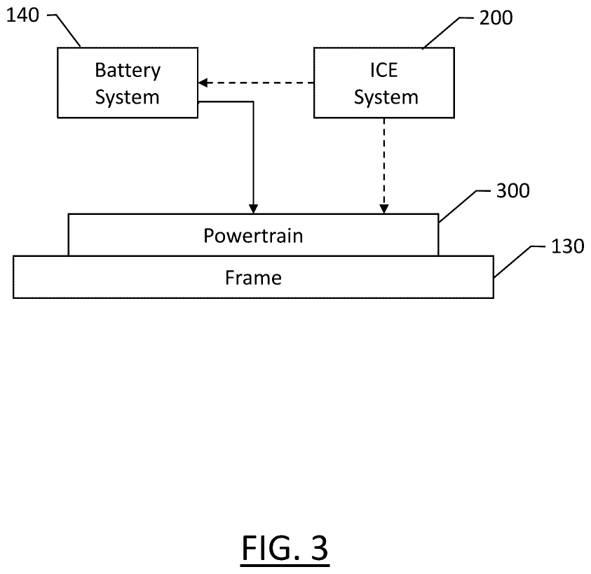

Referring to FIG. 3, a block diagram of a portion of a BEV 100 in accordance with an example embodiment is depicted. As shown, the BEV 100 includes a vehicle frame 130 and a power train 300 carried by the vehicle frame. The power train 300 is configured to provide motive force to the BEV 100 by driving the front wheels 115 and/or rear wheels 120 in response to electrical power provided thereto. As also depicted in FIG. 3, the range extended BEV 100 includes a battery system 140 including a plurality of battery components including one or more batteries that serve to provide electrical power to the power train 300. The BEV 100 also includes an ICE system 200 configured to provide auxiliary power in order to extend the range of the battery electric vehicle. The auxiliary power may be utilized for various purposes as generally indicated by the dashed lines in FIG. 3, such as for recharging the battery system 140 and/or otherwise supplementing the power provided by the battery system by providing electrical power to the power train 300 and/or to other components of the BEV 100. The battery system 140 and the ICE system 200, operating in series or parallel or independently, collectively form the power system of the BEV 100.

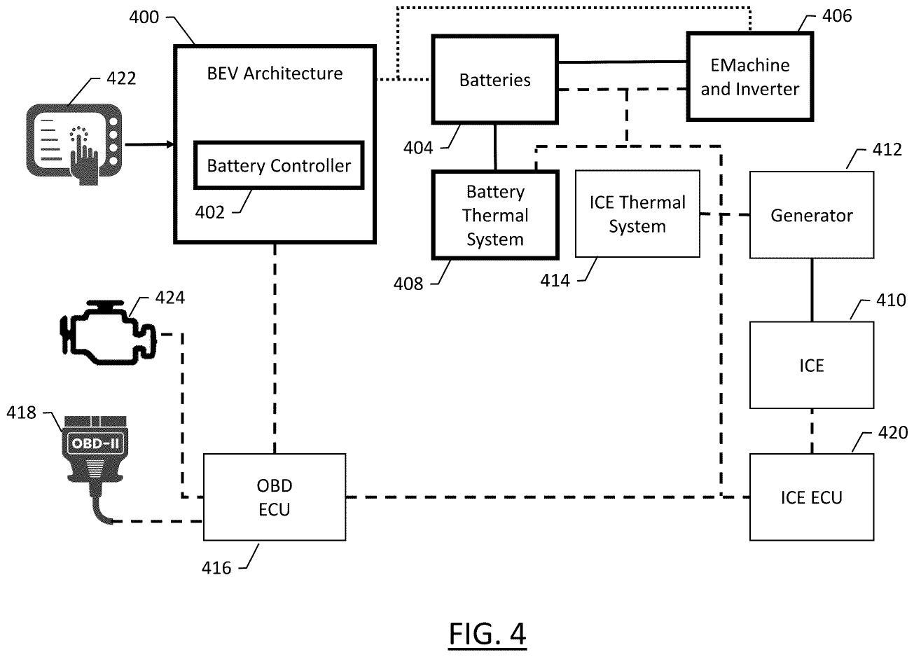

As noted above, both the battery system 140 and the ICE system 200 include a plurality of components, at least some of which are depicted in FIG. 4 with the components of the battery system having a bolded outline relative to the components of the ICE system. In this regard, the battery system 140 of the illustrated embodiment includes a BEV architecture 400 including the vehicle electronics prior to the addition of the ICE system 200 for range extension. The BEV architecture 400 includes a battery controller 402 as well as other components of the vehicle electronics of the battery system 140, such as, for example, one or more electronic control units, wiring and other electronics that serve to control the one or more batteries 404, the battery thermal system 408, the e-machine 416 and inverter as described below, as well as other body controls outside of the propulsion system. In some embodiments, one or more electrical control units, wiring, and other electronics may be in connection with the associated components of the battery system 140, rather than separate from the components in a central BEV architecture, and provide communication to the BEV architecture 400 on behalf of the associated components. The battery controller 402 provides control signals as indicated by the dotted lines to at least some of the other components of the battery system 140 in order to at least partially control operations to be performed by these components. The battery system 140 also includes one or more batteries 404, such as high voltage, e.g., greater than 100 volts, batteries. In some embodiments, one or more batteries 404 may also include an onboard charger. The BEV architecture 400 of the illustrated embodiment may optionally be configured to receive user input, such as via a user interface 422, such as to indicate the mode of operation or provide other information that may then be utilized, such as by the battery controller 402 in generating control signals for at least some of the components of the battery system 140.

As shown in FIG. 3, the battery system 140 also includes an e-machine 406, also known as an electric machine and, more particularly, as an electric propulsion motor, that serves to provide electric power to the power train 300 in response to voltage provided by the one or more batteries 404. In some embodiments, the e-machine 406 may also be associated with an inverter to convert the direct current (DC) voltage provided by the one or more batteries 404 into alternating current (AC) to power the e-machine. Additionally, the battery system 140 of the illustrated embodiment includes a battery thermal system 408 to monitor and control the temperature of the one or more batteries 404. As shown at least the one or more batteries 404 and the e-machine and inverter 406 may operate responsive to control signals from the BEV controller 402 in order to controllably and selectably provide electrical power to the power train 300 and, in turn, provide motive force to the BEV 100. The battery system 140 including the BEV architecture 400 and plurality of battery components do not provide OBD signals in the absence of an ICE system 200 since a BEV 100 that does not include an ICE system is not mandated to provide OBD signals for diagnostic or other purposes.

The ICE system 200 also includes a plurality of components as shown in FIG. 4 with less bold outlines than the components of the battery system 140. The ICE system 200 includes an internal combustion engine (ICE) 410 and a generator 412 that is connected, such as by being mechanically connected to the ICE such that operation of the ICE causes the generator to provide auxiliary power, such as to recharge the one or more batteries 404 of the battery system 140 and/or for other purposes, such as by providing power to other electrical components and/or directly to the power train 300 of the BEV 100 in order to supplement the electrical power provided by the battery system. The ICE system 200 of the illustrated embodiment also includes an ICE thermal system 414 configured to monitor and control the temperature of the generator 412. In order to satisfy the OBD requirements mandated by the inclusion of the ICE system 200 within the range extended BEV 100, the BEV also includes one or more OBD electronic control units 416 that are separate from the battery system 140 and that are configured to receive OBD signals from the ICE system 200, such as a plurality of components of the ICE system 200. The OBD ECU 416 is also configured to receive signals from the battery system 140, such as from a plurality of components of the battery system 140, that are analyzed by the OBD ECU 416 for purposes of meeting the OBD requirements for the battery system 140. In some embodiments, the OBD ECU 416 is configured to receive the signals from the battery system 140 without the signals having been processed by the battery system 140.

Based at least in part upon the signals received from the battery system 140, the OBD ECU 416 may be configured to generate OBD signals for the battery system 140. In regards to generating the OBD signals, the OBD ECU 416 may be configured to parse the signals provided by the battery system 140 to identify one or more signals from the battery system 140 that satisfy the OBD requirements and that serve as is as OBD signals. However, the OBD ECU 416 may also generate OBD signals for the battery system 140 by analyzing and/or processing at least some of the signals from the battery system 140 to create corresponding OBD signals. In either instance, the battery system 140 is dependent upon the OBD ECU 416 to output the resulting OBD signals as the battery system 140 is not configured to provide OBD signals directly to an OBT port 418.

The OBD ECU 416 then outputs the OBD signals towards an OBD port 418 represented by an OBD-II connector for provision to an external system, such as a diagnostic system. In the illustrated embodiment, the OBD ECU 416 that is shown to receive the OBD signals and to provide the OBD signals to an OBD port 418 may be designated a master ECU as shown in FIG. 4. As described below, however, the OBD ECU 416 that receives the OBD signals and then provides the OBD signals to an OBD port 418 may be differently embodied, such as by two or more ECUs that work collaboratively in a distributed manner. Also, while the OBD ECU 416 may be separate from, but in communication with the other components of the ICE system 200 and the components of the battery system 140, the OBD ECU 416 of some embodiments may instead be embodied by an ECU that is associated with one of the individual components, such as the ICE ECU 420 that is associated with the ICE 410 in the illustrated embodiment.

As shown in the example of FIG. 4, the OBD ECU 416 receives OBD signals from the ICE system 200 components, including the ICE 410, ICE ECU 420, generator 412, and the ICE thermal system 414. However, the OBD ECU 416 can receive OBD signals from a greater number or fewer number of components of the ICE system 200 in other embodiments. The OBD signals are signals provided by the various components and/or ECUs associated with the various components that must be monitored for failure, such as by output components controlled by the vehicle, including valve actuators or sensors, that may be utilized for diagnostic purposes, e.g., sensors that detect an increase in emissions. In this regard, the OBD signals may be signals indicative of a particular parameter, such as the value of a particular parameter, e.g., temperature, that may thereafter be analyzed to determine if a fault exists. Additionally or alternatively, the OBD signals may be an indication of a fault, such as determined by a sensor associated with a respective component of the ICE system 200, and then provided to the OBD ECU 416.

In some embodiments, components of the battery system 140, including the battery controller 402, batteries 404, e-machine and inverter 406, and battery thermal system 408, or associated ECUs, may send signals related to the components of the battery system 140. A greater number or fewer number of components of the battery system 140 can send signals in other embodiments. In some embodiments, the BEV architecture 400 can receive the signals from the components of the battery system 140. The signals can come from components that, if they fail, can reduce the range of the BEV or reduce the ability to recapture charge from the brakes. In this regard, the signals may be signals indicative of a particular parameter, such as the value of a particular parameter, e.g., battery temperature, that may thereafter be analyzed to determine if a fault exists. Additionally or alternatively, the signals may be an indication of a fault, such as determined by a sensor associated with a respective component of the battery system 140. The signals may be indicative of one or more failures, a signal indicative of a crash, a signal indicative of an elevated or low temperature of the batteries 404, a signal providing the calibration identification number (CALID) of the BEV 100 and/or the calibration verification number (CVN) of the BEV, or the like. The signals sent from the components of the battery system 140 may not be considered OBD signals in the form they are communicated, or may not be sent for the purpose of meeting OBD requirements.

To meet OBD requirements, the OBD ECU 416 may be configured to receive the signals from one or more components of the battery system 140, the BEV architecture 400, or both. In example embodiments, the signals that the OBD ECU 416 receives from the BEV architecture 400 or the components of the battery system 140 may contain more than one signal. The OBD ECU 416 may be configured to filter the signals that are received so as to separate signals that may be sufficient as is to be provided by the OBD ECU 416 to the OBD port 418 to meet OBD requirements. The OBD ECU 416 may utilize at least some of the other signals received from the BEV architecture 400 or components of the battery system 140 alone or in relation to the analysis of signals provided by other components in order to determine the existence of a fault that may then be reported by the OBD ECU 416 as an OBD signal via the OBD port 418. In some embodiments, the signals required to meet OBD requirements may be contained in the signals received from the BEV architecture 400 alone. In other embodiments, the OBD ECU 416 may need to communicate with the components of the battery system 140, or their associated ECUs, to receive the signals required to meet OBD requirements. In another embodiment, ECUs or other components of the ICE system 200 may receive the signals from the components of the battery system 140 and send them to the OBD ECU 416. In yet other embodiments, the OBD ECU 416 may receive the signals required to meet OBD requirements from a combination of the BEV architecture 400, the ICE system 200, and the battery system 140. In some embodiments, one or more signals required for OBD compliance may not be available from the existing BEV electrical architecture. In these embodiments, simple software changes may be made to the BEV and/or one or more components of the battery system 140 to cause the signals required for OBD compliance to be sent to the OBD ECU 416.

The OBD ECU 416 is also configured to provide the OBD signals to an OBD port 418, such as provided by an OBD-II connector as shown in FIG. 4. In this regard, the OBD ECU 416 may relay the OBD signals toward the OBD port 418 without processing the OBD signals, such as the OBD signals indicative of a fault that has been detected. Additionally or alternatively, the OBD ECU 416 may evaluate the signals that are received, such as the signals that provide information but do not directly indicate that a fault has occurred, e.g., signals indicative of a particular parameter, such as the value of a parameter, to determine if a fault has occurred and, if so, to provide an indication of the fault as an OBD signal to the OBD port 418. In this regard, the OBD ECU 416 may be configured to evaluate the signals that are received and that represent the value of a particular parameter in accordance with a predefined criteria, such as a predefined algorithm, to determine whether a fault has occurred that is to then be reported to the OBD port 418. For example, the OBD ECU 416 may be configured to monitor the temperature of one or more components based on signals from the one or more components and determine if the temperature exceeds the predetermined threshold, such that a fault should be flagged relative to the respective component in an OBD signal provided to the OBD port 418.

The signals, such as OBD signals, signals from the BEV architecture 400 and components of the battery system 416, and/or control signals, may be communicated between the components of the battery system 140, the ICE system 200 and the OBD ECU 416 in any of a variety of manners including, for example, by a bus or other electrical wiring, such as a controller area network (CAN) bus, a FLEXBUS, a FlexRay bus, a local interconnect network (LIN) bus, or the like. In instances in which the OBD ECU 416 provides a signal to the OBD port 418 indicative of the occurrence of a fault, the OBD ECU 416 can be configured to also alert the user interface of the BEV 100, such as for causing an error light, such as a check engine light 424, to be illuminated, for example, on the dash of the BEV.

One or more of the components of the battery system 140 and/or the ICE system 200 may also include an ECU associated therewith. As shown in FIG. 4 by way of example, the ICE 410 includes an ICE ECU 420 associated therewith that receives the OBD signals from the ICE and that provides the OBD signals to the OBD ECU 416, e.g., the master ECU, that communicates with the OBD port 418. Although not depicted, one or more of the other components of the battery system 140 and/or the ICE system 200 may also include a dedicated ECU that receives the signals from the respective component and that provides the signals to the OBD ECU 416, e.g., the master ECU, that is in communication with the OBD port 418. Instead of or in addition to forwarding the OBD signals from a respective component to the OBD ECU 416 that is in communication with the OBD port 418, the ECU that is associated with a particular component of the ICE system 200, such as the ICE ECU 420, may be configured to analyze the signals received from the respective component, such as by evaluating the signals relative to a predefined criteria, and to provide an indication of a fault if a predefined error condition is satisfied with the indication of a fault then being provided as an OBD signal to the OBD ECU 416 that is in communication with the OBD port 418.

The OBD ECU 416 that serves as the master ECU for the BEV 100 may be implemented in any of a number of different manners. For example, the OBD ECU 416 that communicates with the OBD port 418, e.g., the master ECU, may be separate from, but in communication with the components of the battery system 140 and, in some embodiments, the ICE system 200 as shown in FIG. 4. Alternatively, one of the ECUs associated with a component of the ICE system 130, such as the ICE ECU 420 depicted in the embodiment of FIG. 4, may also serve as the master ECU so as to communicate with the OBD port 418 as well as a number of other components of the ICE system 200 and the battery system 140 including the component with which the ICU ECU 420 is associated. Additionally, while a single master ECU 416 is depicted in the embodiment of FIG. 4 and described above, two or more ECUs may collaborate, such as in a distributed manner, in order to perform the functions of a master ECU and to provide OBD signals to the OBD port 418.

The ECUs, including the master ECU, may be implemented in a variety of different architectures. The architectures include a centralized architecture as generally shown in FIG. 4, a distributed architecture in which ECUs are positioned throughout the vehicle and associated with different components of the ICE system 200 and the battery system 140 with each or at least a number of the ECUs being configured to serve as a master ECU and communicate with the OBD port 418. Alternatively, the ECUs may be associated with a gateway and/or different functional areas of the vehicle, such as the battery system 140 and the ICE system 200 in a domain architecture. Further, of the ECUs that collectively serve as a master ECU may be associated with and in communication with one or more zonal gateways in a zonal electrical/electronic architecture. As such, the depiction of the master ECU 416 in communication with the battery system 140 and the ICE system 200 of FIG. 4 is not intended to limit the manner in which the master ECU is deployed as other embodiments may include one or more ECUs implemented in other configurations.

In an example embodiment, the OBD ECU 416 may be associated with the ICE system 200, such that it is installed in the BEV when the ICE system 200 is installed in the BEV. The OBD ECU may be connected to the components of the ICE system 200 prior to installation in the BEV. To complete installation in the BEV, the OBD ECU 416 may be configured to connect to the existing BEV electrical architecture through a single quick connector that easily connects and disconnects and that provides all necessary signals related to the battery system 140. In another embodiment, the OBD ECU 416 may connect to the BEV architecture and/or one or more components of the battery system 140 by connecting to existing wiring in the BEV electrical system. In some embodiments, some minor changes may be required to the BEV electrical architecture to send the required signals to the OBD ECU 416. However, these embodiments advantageously require much fewer changes in logic or software compared to adding functionality to and increasing the ability to store necessary data for each battery system 140 component to meet OBD requirements.

The ICE system 200 of some embodiments may be configured to operate in certain predefined conditions, while remaining offline or otherwise inoperable in other instances. For example, the OBD ECU 416 may be configured to detect a predefined state of charge (SOC) of one or more batteries 404. In this embodiment, the OBD ECU 416 may also be configured to cause operation of the ICE 410 to commence in response to detecting that the SOC satisfies a predefined SOC, such as by being equal to or less than the predefined SOC, in order to provide auxiliary power, such as to recharge the one or more batteries 404. In this embodiment, once the OBD ECU 416 determines that the state of charge exceeds a second, greater predefined SSC, the OBD ECU may be configured to cause operation of the ICE 410 to cease, such as conserve fuel and increase the efficiency of the BEV 100.

In another embodiment, the OBD ECU 416 may be configured to detect that the BEV 100 is towing, such as towing a boat, a trailer or the like. The OBD ECU 416 may detect that the BEV 100 is towing utilizing any of a variety of techniques including, for example, detecting or receiving a signal from the BEV 100 indicating that the BEV is drawing additional power as would be required for towing, receiving a signal from optical sensors having a field of view of the rear of the vehicle for detecting the presence of a trailer or other towed object, receiving a signal indicting that the trailer plug is in use or receiving a signal provided by a user of the BEV, such as via a user interface, indicating that the vehicle is towing. In response to determining that the BEV 100 is towing, the OBD ECU 416 may be configured to cause operation of the ICE to commence in response to detecting that the BEV 100 is towing in order to provide auxiliary power, such as to recharge the one or more batteries 404. Once the BEV 100 is no longer towing or once the one or more batteries 404 are recharged to a predefined state of charge, the OBD ECU 416 may be configured to cause operation of the ICE 410 to cease so as to conserve fuel and increase the efficiency of the BEV.

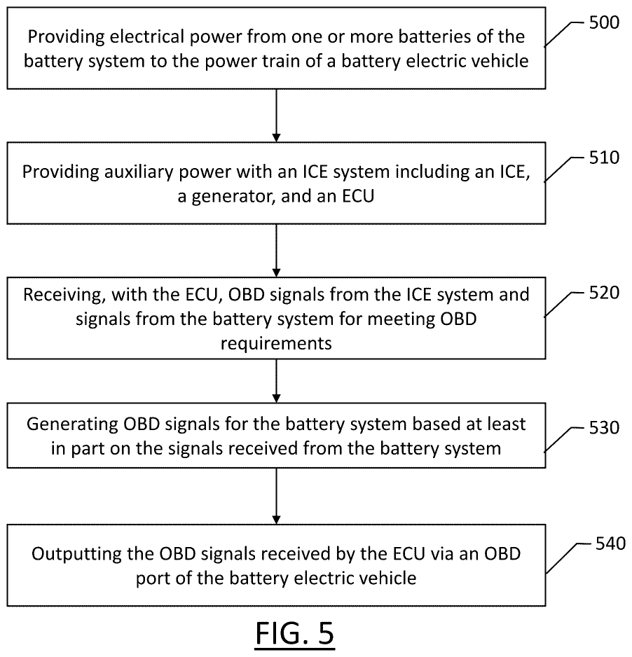

Referring now to FIG. 5, the operations performed for extending the range of a BEV 100 are depicted. As shown in block 500, electrical power can be provided from one or more batteries 404 to the power train 300 of the BEV 100 in response to control signals provided by the battery controller 402 to the one or more batteries. Auxiliary power may be provided by the ICE system 200 in order to extend the range of the BEV 100, as shown in block 510. For example, the auxiliary power may be utilized to recharge the one or more batteries 404 of the battery system 140 or to otherwise supplement the one or more batteries, such as by providing electrical power to other components of the BEV 100 and/or providing electrical power to the power train 300. The BEV 100 also includes an OBD ECU 416, namely, a master ECU, that is separate from the battery system and that is configured to provide control signals to the ICE system. As shown block 520 of FIG. 5, OBD signals are received, such as by the OBD ECU 416 and from the ICE system 200, such as one or more of the plurality of components of the ICE system, and signals are received from the battery system 140, such as from the one or more components of the battery system, for meeting the OBD requirements.

As shown in block 530, OBD signals for the battery system 140 may be generated, with the OBD ECU 416, based at least in part on the signals received from the battery system. The OBD signals are then output by the OBD ECU 416, such as via an OBD port 418, to an external device, as shown in block 540. In an example embodiment, at least some of the OBD signals from the ICE system 200 or some of the signals received from the battery system 140 may be analyzed by the OBD ECU 416 in accordance with a predefined algorithm to detect existence of a fault. An indication of the fault may be output as an OBD signal from the OBD ECU 416 toward the OBD port 418.

Based on the OBD signals that are output, the source of various faults may be identified and other types of diagnostic assessment may be conducted. In this regard, the provision of the OBD signals via the OBD port 418 permit diagnostic assessments to be performed not only with respect to the components of the ICE system 200, but also with respect to the components of the battery system 140. In this regard, even though the battery system 140 of the BEV 100 was not configured to provided OBD signals in the absence of the ICE system 200, the addition of the ICE system to the range extended BEV also provides for the provision of the OBD signals from the components of the battery system 140 without much, if any, reconfiguration of the battery system.

In an example embodiment, the method also includes controlling the temperature of one or more batteries 404 by the battery thermal system 408. Similarly, the temperature of the generator 412 of the ICE system 200 may be controlled by the ICE thermal system 414, separate from the battery thermal system 408. In this example embodiment, the method also includes receiving, with the OBD ECU 416, signals from the battery thermal system 408 and the ICE thermal system 414 and outputting the signals received from the battery thermal system and the ICE thermal system.

The ICE system 200 of the BEV 100 may be controllably activated and deactivated in order to provide auxiliary power in instances in which the operation of the BEV 100 would benefit from the auxiliary power, but to cease operation of the ICE system in other instances in order to increase the efficiency of the BEV. In one embodiment, the method controls operation of the ICE system 200 based on the state of charge (SOC) of the one or more batteries 404. In this embodiment, the method detects a predefined SOC) of the one or more batteries 404. In response to detecting the predefined SOC, such as in an instance in which the SOC of the one or more batteries 404 is less than or equal to the predefined SOC, the method causes operation of the ICE 410 to commence in order to recharge the one or more batteries. Once the SOC of the one or more batteries 404 is increased, such as to a second SOC, greater than the predefined SOC, the operation of the ICE 410 may be ceased so as to increase the efficiency of the BEV 100.

In another embodiment, the method controls operation of the ICE system 200 based on the mode of operation of the BEV 100, such as by causing the ICE system to operate in an instance in which the BEV is towing. In this embodiment, the method detects that the BEV 100 is towing. In response to detecting that the BEV 100 is towing, the method causes operation of the ICE 410 to commence in order to recharge the one or more batteries 404. Once the BEV 100 is determined to no longer be towing, the operation of the ICE 410 may be ceased so as to increase the efficiency of the BEV 100.

A BEV 100 is provided in accordance with an example embodiment that includes an ICE system 200 in order to extend the range of the BEV. With the addition of the ICE system 200, OBD signals must be provided, such as via an OBD port 418, for diagnostic purposes even though the battery system 140 was not mandated to and did not provide OBD signals, such as for diagnostic purposes, prior to the addition of the ICE system 200 in order to extend the range of the BEV 100. As such, the range extended BEV 100 and, more particularly, the OBD ECU 416 is configured to provide OBD signals from both the ICE system 200 and the battery system 140 in a manner that limits or avoid modifications to the battery system, thereby permitting the BEV to be range extended by the addition of an ICE system in an efficient manner with reduced complexity and cost.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the embodiments set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A battery electric vehicle comprising:
a vehicle frame;
a power train carried by the vehicle frame and configured to provide motive force to the battery electric vehicle in response to electrical power provided thereto;
a battery system comprising a battery controller and one or more batteries responsive to battery control signals provided by the battery controller in order to provide the electrical power to the power train;
an internal combustion engine (ICE) system to extend a range of the battery electric vehicle, the ICE system comprising a plurality of ICE components including an ICE and a generator driven by the ICE; and
an on board diagnostic (OBD) electronic control unit (ECU), separate from the battery system, configured to receive OBD signals from the ICE system and signals from the battery system for meeting OBD requirements.

2. A battery electric vehicle according to claim 1, wherein the OBD ECU is configured to generate OBD signals for the battery system based at least in part on the signals received from the battery system.

3. A battery electric vehicle according to claim 2, further comprising an OBD port configured to receive the OBD signals from the OBD ECU and to output the OBD signals to an external device.

4. A battery electric vehicle according to claim 3, wherein the battery system is dependent upon the OBD ECU to output the OBD signals toward the OBD port as the battery system is not configured to provide OBD signals directly to the OBD port.

5. A battery electric vehicle according to claim 3, wherein the OBD ECU is configured to analyze at least some of the OBD signals from the ICE system or some of the signals from the battery system in accordance with a predefined algorithm to detect existence of a fault, and wherein the ECU is also configured to output an indication of the fault as an OBD signal toward the OBD port.

6. A battery electric vehicle according to claim 1, wherein the battery system comprises a plurality of battery components including the battery controller, the one or more batteries, an e-machine, an inverter, and a battery thermal system, and wherein the OBD ECU is configured to receive the signals from one or more of the plurality of battery components.

7. A battery electric vehicle according to claim 6, wherein the ICE system further comprises an ICE electrical control unit that is configured to receive OBD signals from one or more of the ICE or the generator, wherein the ICE electrical control unit is further configured to receive signals from one or more of the plurality of battery components, such that the ICE electrical control unit functions as the OBD ECU.

8. A battery electric vehicle according to claim 1, wherein the OBD ECU is also configured to receive predefined types of signals from the battery controller.

9. A battery electric vehicle according to claim 1, wherein the OBD ECU is configured to receive the signals from the battery system without the signals having been processed by the battery system.

10. A battery electric vehicle according to claim 1, wherein the battery system further comprises a battery system ECU configured to receive the signals from other battery components including the one or more batteries, and wherein the OBD ECU is configured to receive the signals from the battery system by receiving the signals from the battery system ECU.

11. A battery electric vehicle according to claim 1, wherein the OBD ECU is configured to receive signals from at least one of the ICE system or the battery system that include the OBD signals and other types of signals, and wherein the OBD ECU is configured to filter the signals that are received to separate the OBD signals from the other types of signals.

12. A power system of a battery electric vehicle, the power system comprising:
a battery system comprising a battery controller and one or more batteries responsive to battery control signals provided by the battery controller in order to provide electrical power to a power train of the battery electric vehicle;
an internal combustion engine (ICE) system to extend a range of the battery electric vehicle, the ICE system comprising a plurality of ICE components including an ICE and a generator driven by the ICE; and
an on board diagnostic (OBD) electronic control unit (ECU), separate from the battery system, configured to receive OBD signals from the ICE system and signals from the battery system for meeting OBD requirements.

13. A power system according to claim 12, wherein the OBD ECU is configured to generate OBD signals for the battery system based at least in part on the signals received from the battery system.

14. A power system according to claim 13, further comprising an OBD port configured to receive the OBD signals from the OBD ECU and to output the OBD signals to an external device.

15. A power system according to claim 14, wherein the battery system is dependent upon the OBD ECU to output the OBD signals toward the OBD port as the battery system is not configured to provide OBD signals directly to the OBD port.

16. A power system according to claim 14, wherein the OBD ECU is configured to analyze at least some of the OBD signals from the ICE system or some of the signals from the battery system in accordance with a predefined algorithm to detect existence of a fault, and wherein the OBD ECU is also configured to output an indication of the fault as an OBD signal toward the OBD port.

17. A power system according to claim 12, wherein the OBD ECU is configured to receive the signals from the battery system without the signals having been processed by the battery system.

18. A method for integrating an internal combustion engine (ICE) system with a battery system of a battery electric vehicle, the method comprising:
providing electrical power from one or more batteries of the battery system to a power train of the battery electric vehicle in response to battery control signals from a battery controller of the battery system;
providing auxiliary power with the ICE system, wherein the ICE system comprises a plurality of ICE components including an ICE and a generator driven by the ICE and configured to provide the auxiliary power in order to extend a range of the battery electric vehicle; and
receiving, with an on board diagnostic (OBD) electronic control unit (ECU) that is separate from the battery system, OBD signals from the ICE system and signals from the battery system for meeting OBD requirements.

19. A method according to claim 18, further comprising:
generating, with the OBD ECU, OBD signals for the battery system based at least in part on the signals received from the battery system; and
outputting the OBD signals received from the OBD ECU via an OBD port of the batter electric vehicle.

20. A method according to claim 19, further comprising:
analyzing, with the OBD ECU, at least some of the OBD signals from the ICE system or some of the signals from the battery system in accordance with a predefined algorithm to detect existence of a fault; and
outputting an indication of the fault as an OBD signal from the OBD ECU toward the OBD port.
